(19) United States
(12) Patent Application Publication
(10) Pub. No.: US 2025/0370132 A1
(43) Pub. Date: Dec. 4, 2025

(54) DISTANCE IMAGE CAPTURING DEVICE AND DISTANCE IMAGE CAPTURING METHOD

(71) Applicant: TOPPAN Holdings Inc., Tokyo (JP)

(72) Inventors: Hiromitsu HARIU, Tokyo (JP); Takahiro AKUTSU, Tokyo (JP); Takehide SAWAMOTO, Tokyo (JP); Kunihiro HATAKEYAMA, Tokyo (JP)

(73) Assignee: TOPPAN Holdings Inc., Tokyo (JP)

(21) Appl. No.: 19/222,289

(22) Filed: May 29, 2025

(30) Foreign Application Priority Data
May 31, 2024 (JP) 2024-088938

(51) Int. Cl. G01S 17/10; H04N 23/56; H04N 25/53; H04N 25/626

(52) U.S. Cl. CPC G01S 17/10; H04N 23/56; H04N 25/53; H04N 25/626

(57) ABSTRACT

A first measurement and a second measurement are performed, an adjustment target object is selected from the subject based on a pixel signal obtained by the first measurement, the number of times of integration is calculated in the second measurement based on the pixel signal of the pixels corresponding to the adjustment target object in the first measurement, a range shift amount which is the minimum value of the distance as a measurement target, which is determined in correspondence with a time interval from the emission timing to the accumulation timing is calculated, based on the distance to the adjustment target object in the first measurement, the second measurement is performed with the calculated number of times of integration and the calculated range shift amount, and a distance image is generated based on the pixel signal obtained in accordance with each measurement of the first measurement and the second measurement.

### CROSS REFERENCE TO RELATED APPLICATIONS

This application is a continuation application based on Japanese Patent Application No. 2024-088938, filed on May 31, 2024, in the Japan Patent Office. The contents of the Japanese Patent Application are incorporated herein by reference.

### BACKGROUND OF THE INVENTION

### Field of the Invention

The present invention relates to a distance image capturing device and a distance image capturing method.

### Description of Related Art

A time of flight (hereinafter, referred to as “TOF”) type distance image capturing device that uses a known speed of light and measures a distance between a measurement instrument and a target object based on a flight time of light in a measurement space is implemented (for example, refer to Japanese Patent No. 4235729).

In such a distance image capturing device, a delay time from the time when an optical pulse, which is a pulsed near-infrared light, is emitted until the optical pulse reflected by a subject returns is obtained by accumulating an electric charge generated by a photoelectric conversion element in a plurality of charge accumulation units, and the distance to the subject is calculated using the delay time and the speed of light.

### SUMMARY OF THE INVENTION

In order to accurately calculate the distance using such a distance image capturing device, it is required to increase a ratio (SN ratio) of a signal to noise. In order to increase the SN ratio, it is useful to increase an exposure time. However, in a case where a subject at a short distance or a subject having a high reflectivity is present in an imaging area that is a measurement target, an amount of reflected light is large, and when the exposure time is long, electric charge amounts accumulated in the charge accumulation unit exceed an upper limit, a pixel signal is saturated, and the distance cannot be calculated. As a countermeasure, there is a technology of auto exposure (AE) that automatically adjusts the exposure time to be as long as possible within a range in which the pixel signal is not saturated according to an imaging environment.

On the other hand, in the distance image capturing device, flare may occur due to a large amount of the reflected light arriving from the subject at a short distance, and the accuracy of distance measurement may be reduced due to the flare. Here, the flare is a phenomenon in which the reflected light from the subject at a short distance is re-reflected on a sensor surface, diffuse reflection occurs between a lens and a sensor, and noise that particularly reduces the distance accuracy to the subject at a long distance appears.

The present invention is made in order to solve the above-described problems, and an object of the present invention is to provide a distance image capturing device and a distance image capturing method capable of appropriately setting an exposure time and suppressing an influence of a flare.

A distance image capturing device of the present invention includes a light source unit that is configured to emit an optical pulse to a measurement space; a light receiving unit that includes a pixel circuit in which a plurality of pixels, each including a photoelectric conversion element that generates an electric charge in accordance with incident light and a plurality of charge accumulation units that accumulate the electric charge are arranged in a two-dimensional matrix, and a pixel driving circuit which distributes and accumulates the electric charge in each of the charge accumulation units at a predetermined accumulation timing synchronized with an emission timing at which the optical pulse is emitted; and a distance image processing unit that is configured to calculate the distance to a subject present in the measurement space based on an electric charge amount accumulated in each of the charge accumulation units, in which the distance image processing unit performs a first measurement and a second measurement, classifies the pixels into at least two groups having different numbers of times of integration for repeating processing of accumulating the electric charge in each of the charge accumulation units in the first measurement, and performs even odd high dynamic range (eoHDR) driving that is driven such that the electric charge is accumulated in each of the charge accumulation units in the number of times of integration of each of the groups, selects an adjustment target object from the subject based on a pixel signal which is obtained by the first measurement, the pixel signal corresponding to the electric charge amount accumulated in each of the charge accumulation units, calculates the number of times of integration in the second measurement based on the pixel signal of the pixels corresponding to the adjustment target object in the first measurement, calculates a range shift amount which is the minimum value of the distance as a measurement target, which is determined in correspondence with a time interval from the emission timing to the accumulation timing in the second measurement, based on the distance to the adjustment target object in the first measurement, performs the second measurement with the calculated number of times of integration and the calculated range shift amount, and generates a distance image based on the pixel signal obtained in accordance with each measurement of the first measurement and the second measurement.

A distance image capturing method of the present invention is a distance image capturing method performed by a distance image capturing device including a light source unit that is configured to emit an optical pulse to a measurement space, a light receiving unit that includes a pixel circuit in which a plurality of pixels, each including a photoelectric conversion element that generates an electric charge in accordance with incident light and a plurality of charge accumulation units that accumulate the electric charge are arranged in a two-dimensional matrix, and a pixel driving circuit which distributes and accumulates the electric charge in each of the charge accumulation units at a predetermined accumulation timing synchronized with an emission timing at which the optical pulse is emitted, and a distance image processing unit that is configured to calculate the distance to a subject present in the measurement space based on an electric charge amount accumulated in each of the charge accumulation units, in which the distance image processing unit performs a first measurement and a second measurement, classifies the pixels into at least two groups having different numbers of times of integration for repeating processing of accumulating the electric charge in each of the charge accumulation units in the first measurement, and performs even odd high dynamic range (eoHDR) driving that is driven such that the electric charge is accumulated in each of the charge accumulation units in the number of times of integration of each of the groups, selects an adjustment target object from the subject based on a pixel signal which is obtained by the first measurement, the pixel signal corresponding to the electric charge amount accumulated in each of the charge accumulation units, calculates the number of times of integration in the second measurement based on the pixel signal of the pixels corresponding to the adjustment target object in the first measurement, calculates a range shift amount which is the minimum value of the distance as a measurement target, which is determined in correspondence with a time interval from the emission timing to the accumulation timing in the second measurement, based on the distance to the adjustment target object in the first measurement, performs the second measurement with the calculated number of times of integration and the calculated range shift amount, and generates a distance image based on the pixel signal obtained in accordance with each measurement of the first measurement and the second measurement.

According to the present invention, it is possible to appropriately set the exposure time and suppress the influence of the flare.

### BRIEF DESCRIPTION OF THE DRAWINGS

FIG. 1 is a block diagram showing a configuration example of a distance image capturing device 1 according to an embodiment.

FIG. 2 is a block diagram showing a configuration example of a distance image sensor 32 according to an embodiment.

FIG. 3 is a circuit diagram showing a configuration example of a pixel 321 according to an embodiment.

FIG. 4 is a flowchart showing a flow of processing performed by the distance image capturing device 1 of the embodiment.

FIG. 5A is a diagram showing dHDR driving as a driving method performed by the distance image capturing device 1 of the embodiment.

FIG. 5B is a diagram showing dHDR driving as a driving method performed by the distance image capturing device 1 of the embodiment.

FIG. 5C is a diagram showing dHDR driving as a driving method performed by the distance image capturing device 1 of the embodiment.

FIG. 5D is a diagram showing dHDR driving as a driving method performed by the distance image capturing device 1 of the embodiment.

FIG. 6A is a diagram showing eoHDR driving as a driving method performed by the distance image capturing device 1 of the embodiment.

FIG. 6B is a diagram showing eoHDR driving as a driving method performed by the distance image capturing device 1 of the embodiment.

FIG. 6C is a diagram showing eoHDR driving as a driving method performed by the distance image capturing device 1 of the embodiment.

FIG. 6D is a diagram showing eoHDR driving as a driving method performed by the distance image capturing device 1 of the embodiment.

FIG. 6E is a diagram showing eoHDR driving as a driving method performed by the distance image capturing device 1 of the embodiment.

FIG. 7A is a diagram showing range shift driving as a driving method performed by the distance image capturing device 1 of the embodiment.

FIG. 7B is a diagram showing range shift as a driving method performed by the distance image capturing device 1 of the embodiment.

FIG. 7C is a diagram showing range shift driving as a driving method performed by the distance image capturing device 1 of the embodiment.

FIG. 7D is a diagram showing range shift driving as a driving method performed by the distance image capturing device 1 of the embodiment.

FIG. 7E is a diagram showing range shift driving as a driving method performed by the distance image capturing device 1 of the embodiment.

FIG. 8 is a diagram showing processing of calculating the number of times of integration performed by the distance image capturing device 1 of the embodiment.

FIG. 9A is a diagram showing processing of calculating the number of times of integration performed by the distance image capturing device 1 of the embodiment.

FIG. 9B is a diagram showing processing of calculating the number of times of integration performed by the distance image capturing device 1 of the embodiment.

FIG. 9C is a diagram showing processing of calculating the number of times of integration performed by the distance image capturing device 1 of the embodiment.

FIG. 10A is a diagram showing processing of calculating the number of times of integration performed by the distance image capturing device 1 of the embodiment.

FIG. 10B is a diagram showing processing of calculating the number of times of integration performed by the distance image capturing device 1 of the embodiment.

FIG. 10C is a diagram showing processing of calculating the number of times of integration performed by the distance image capturing device 1 of the embodiment.

FIG. 11A is a diagram showing processing of calculating the number of times of integration performed by the distance image capturing device 1 of the embodiment.

FIG. 11B is a diagram showing processing of calculating the number of times of integration performed by the distance image capturing device 1 of the embodiment.

FIG. 11C is a diagram showing processing of calculating the number of times of integration performed by the distance image capturing device 1 of the embodiment.

FIG. 12A is a diagram showing processing of calculating a range shift amount performed by the distance image capturing device 1 of the embodiment.

FIG. 12B is a diagram showing processing of calculating a range shift amount performed by the distance image capturing device 1 of the embodiment.

FIG. 12C is a diagram showing processing of calculating a range shift amount performed by the distance image capturing device 1 of the embodiment.

### DETAILED DESCRIPTION OF THE INVENTION

Hereinafter, a distance image capturing device of an embodiment will be described with reference to the drawings.

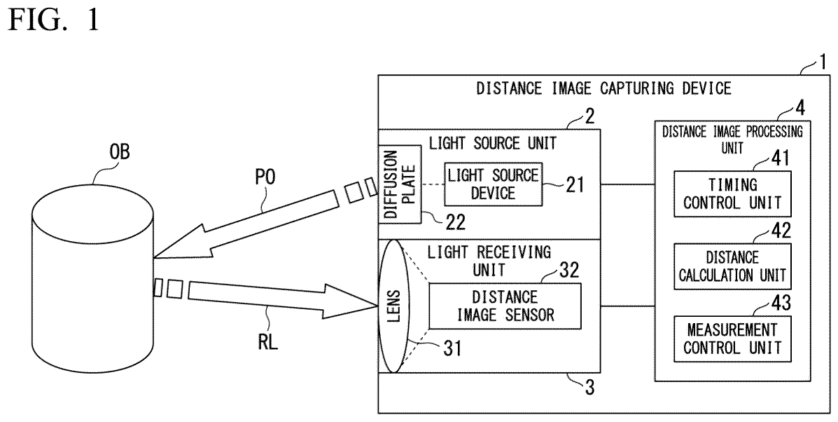

FIG. 1 is a block diagram showing a schematic configuration of the distance image capturing device according to the embodiment. A distance image capturing device 1 includes, for example, a light source unit 2, a light receiving unit 3, and a distance image processing unit 4. FIG. 1 also shows a subject OB that is a target object to which the distance image capturing device 1 measures the distance.

The light source unit 2 emits an optical pulse PO to the subject OB under the control of the distance image processing unit 4. For example, the light source unit 2 is a surface-emitting type semiconductor laser module such as a vertical cavity surface emitting laser (VCSEL). The light source unit 2 includes a light source device 21 and a diffusion plate 22.

The light source device 21 is a light source that emits laser light in a near-infrared wavelength band (for example, a wavelength band with a wavelength of 850 nm to 940 nm) as the optical pulse PO to be emitted to the subject OB. The light source device 21 is, for example, a semiconductor laser light emitting element. The light source device 21 emits pulsed laser light under the control of a timing control unit 41.

The diffusion plate 22 is an optical component that diffuses the laser light of the near-infrared wavelength band emitted by the light source device 21 to a size of a surface for emitting the laser light to the subject OB. The pulsed laser light diffused by the diffusion plate 22 is emitted as the optical pulse PO, and emitted to the subject OB.

The light receiving unit 3 receives reflected light RL of the optical pulse PO reflected by the subject OB and outputs a pixel signal corresponding to the received reflected light RL. The light receiving unit 3 includes a lens 31 and a distance image sensor 32.

The lens 31 is an optical lens that guides the incident reflected light RL to the distance image sensor 32. The lens 31 emits the incident reflected light RL to a distance image sensor 32 side, and causes the reflected light RL to be received by (incident on) pixels provided in a light receiving region of the distance image sensor 32.

The distance image sensor 32 is an imaging element. The distance image sensor 32 includes a plurality of pixels arranged in a two-dimensional matrix. Each of the pixels of the distance image sensor 32 includes one photoelectric conversion element, a plurality of charge accumulation units corresponding to the one photoelectric conversion element, and a component that distributes electric charges to each of the charge accumulation units. That is, the pixel is an imaging element by which electric charges are distributed and accumulated in the plurality of charge accumulation units.

The distance image sensor 32 distributes electric charges generated by the photoelectric conversion element to each of the charge accumulation units, under the control of the timing control unit 41. In addition, the distance image sensor 32 outputs a pixel signal corresponding to an electric charge amount distributed to the charge accumulation units. A plurality of pixels are arranged in a two-dimensional matrix in the distance image sensor 32 which outputs a pixel signal of one frame corresponding to each of pixels.

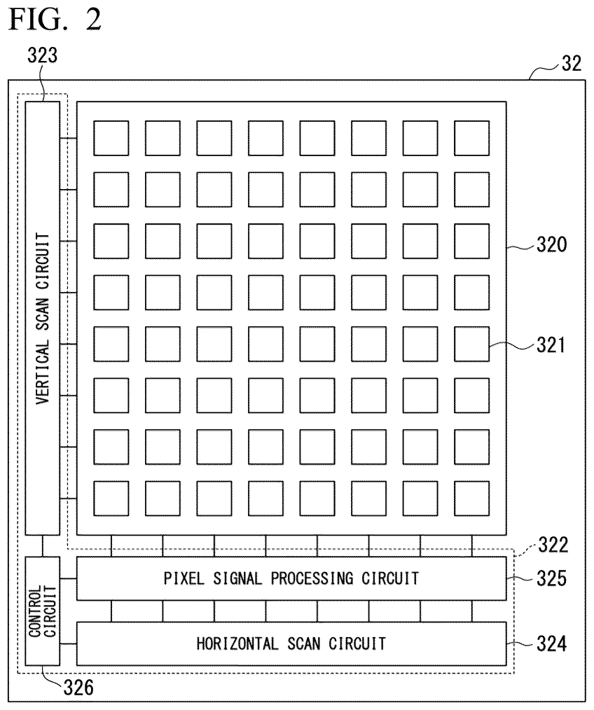

Here, a configuration of the distance image sensor 32 will be described with reference to FIG. 2. FIG. 2 is a block diagram showing a schematic configuration of an imaging element (the distance image sensor 32) used in the distance image capturing device 1 according to the embodiment.

As shown in FIG. 2, the distance image sensor 32 includes, for example, a light receiving region 320 in which a plurality of pixels 321 are arranged in a two-dimensional matrix, and a pixel driving circuit 322. The pixel driving circuit 322 includes, for example, a vertical scan circuit 323 having a distribution operation, a horizontal scan circuit 324, a pixel signal processing circuit 325, and a control circuit 326.

The light receiving region 320 is a region in which the plurality of pixels 321 are arranged in the two-dimensional matrix, and FIG. 2 shows an example in which the plurality of pixels 321 are arranged in the two-dimensional matrix form of eight rows and eight columns. The pixel 321 accumulates electric charges corresponding to the received amount of light and outputs an accumulation signal corresponding to the accumulated electric charge amount.

The control circuit 326 collectively controls the distance image sensor 32. For example, the control circuit 326 controls operations of components of the distance image sensor 32 in response to an instruction from the timing control unit 41 of the distance image processing unit 4. The components provided in the distance image sensor 32 may be controlled directly by the timing control unit 41, and in this case, the control circuit 326 can also be omitted.

The vertical scan circuit 323 controls the pixels 321 arranged in the light receiving region 320 for each row under the control of the control circuit 326. The vertical scan circuit 323 outputs a voltage signal according to the electric charge amount accumulated in each of charge accumulation units CS of the pixel 321 to the pixel signal processing circuit 325. For example, the vertical scan circuit 323 distributes the electric charges converted by a photoelectric conversion element to each of the charge accumulation units of the pixels 321 at an accumulation timing synchronized with emission of the optical pulse PO and accumulates the electric charges therein. In addition, the vertical scan circuit 323 discharges the electric charges converted by the photoelectric conversion element from a charge discharging unit (a drain gate transistor GD to be described below) in a period (for example, a readout period) different from an accumulation period in which the electric charges are accumulated in the charge accumulation unit CS.

The pixel signal processing circuit 325 performs predetermined signal processing (for example, noise suppression processing, A/D conversion processing, or the like) for a voltage signal output to a corresponding vertical signal line from the pixels 321 in each of columns under the control of the control circuit 326.

The horizontal scan circuit 324 sequentially outputs signals output from the pixel signal processing circuit 325 in time series under the control of the control circuit 326. Thereby, an accumulation signal of one frame is sequentially output to the distance image processing unit 4. Hereinafter, a description is made in which it is assumed that the pixel signal processing circuit 325 performs A/D conversion processing and the accumulation signal is a digital signal.

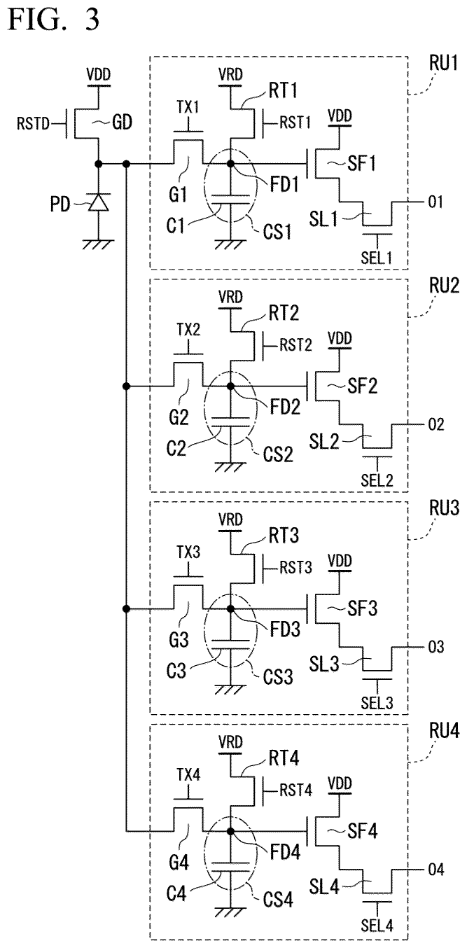

Here, a configuration of the pixel 321 will be described with reference to FIG. 3. FIG. 3 is a circuit diagram showing an example of the pixel 321. FIG. 3 shows an example of the configuration of one pixel 321 among the plurality of pixels 321 arranged in the light receiving region 320. In FIG. 3, an example in which the pixel 321 includes four signal readout units RU (signal readout units RU1 to RU4) is shown.

The pixel 321 includes one photoelectric conversion element PD, the drain gate transistor GD, and the four signal readout units RU that output the voltage signals from the corresponding output terminals O. Each of the signal readout units RU includes a readout gate transistor G, a floating diffusion FD, a charge accumulation capacitor C, a reset transistor RT, a source follower transistor SF, and a select transistor SL. The charge accumulation unit CS is configured by the floating diffusion FD and the charge accumulation capacitor C.

In FIG. 3, respective signal readout units RU are distinguished by assigning any one number of “1” to “4” after the reference numeral “RU” of the four signal readout units RU. In addition, likewise, each of the components included in the four signal readout units RU is also represented by distinguishing the signal readout units RU corresponding to the respective component by indicating the number representing each signal readout unit RU after the reference numeral.

In the pixel 321, the signal readout unit RU1 outputs a voltage signal from an output terminal O1. The signal readout unit RU1 includes a readout gate transistor G1, a floating diffusion FD1, a charge accumulation capacitor C1, a reset transistor RT1, a source follower transistor SF1, and a select transistor SL1. The charge accumulation unit CS1 is configured with the floating diffusion FD1 and the charge accumulation capacitor C1. Signal readout units RU2 to RU4 also have the same configuration.

The photoelectric conversion element PD is an embedded photodiode that photoelectrically converts incident light to generate electric charges according to intensity of the incident light and accumulates the generated electric charges. The photoelectric conversion element PD may have any structure. The photoelectric conversion element PD may be, for example, a PN photodiode having a structure in which a P-type semiconductor and an N-type semiconductor are bonded together, or a PIN photodiode having a structure in which an I-type semiconductor is interposed between the P-type semiconductor and the N-type semiconductor. In addition, the photoelectric conversion element PD is not limited to the photodiode and may be, for example, a photogate type photoelectric conversion element.

The drain gate transistor GD is a transistor for discarding the electric charge generated in the photoelectric conversion element PD. When the drain gate transistor GD is controlled to be in an on-state by the pixel driving circuit 322, the drain gate transistor GD discards the electric charge generated in the photoelectric conversion element PD (that is, resets the photoelectric conversion element PD).

The pixel driving circuit 322 drives the pixels 321, distributes electric charges generated by photoelectrically converting the incident light by using the photoelectric conversion element PD to each of the four charge accumulation units CS, and outputs each of voltage signals corresponding to the electric charge amount of the distributed electric charges to the pixel signal processing circuit 325.

For example, in driving the pixels 321, the pixel driving circuit 322 controls accumulation drive signals TX1 to TX4 corresponding to each of the charge accumulation units CS1 to CS4 to be sequentially the on-state in synchronization with an emission timing of the optical pulse PO. As a result, the readout gate transistors G1 to G4 corresponding to the respective charge accumulation units CS are made to conduct in order, and the electric charge is distributed and accumulated in the corresponding charge accumulation unit CS. Thereby, the electric charges are accumulated in the charge accumulation units CS1, CS2, CS3, and CS4 in ascending order.

The pixel 321 is not limited to the configuration including the four signal readout units RU as shown in FIG. 3, and may have a configuration including a plurality of signal readout units RU. That is, the number of signal readout units RU (the charge accumulation units CS) included in the pixels arranged in the distance image sensor 32 may be two, three, or five or more.

In addition, FIG. 3 shows an example in which the charge accumulation unit CS is configured by the floating diffusion FD and the charge accumulation capacitor C. However, the charge accumulation unit CS may be configured by at least the floating diffusion FD, and the pixel 321 may not include the charge accumulation capacitor C.

Returning to the description of FIG. 1, the distance image processing unit 4 controls the distance image capturing device 1 to calculate the distance to the subject OB. The distance image processing unit 4 includes the timing control unit 41, a distance calculation unit 42, and a measurement control unit 43.

The timing control unit 41 controls timing of outputting various control signals required for measurement under the control of the measurement control unit 43. The various control signals here include, for example, a signal that controls emission of the optical pulse PO, a signal that distributes the reflected light RL to the plurality of charge accumulation units to be accumulated therein, a signal that controls the number of times of integration per frame, and the like.

The number of times of integration is the number of repetition times of processing of distributing and accumulating the electric charge in the charge accumulation unit CS (see FIG. 3) per frame. A product of the number of times of integration and the time (accumulation time) for accumulating the electric charge in each charge accumulation unit in one time of processing of distributing and accumulating the electric charge is the exposure time per frame.

The distance calculation unit 42 outputs distance information obtained by calculating the distance to the subject OB based on the pixel signal output from the distance image sensor 32. The distance calculation unit 42 calculates a delay time from emitting the optical pulse PO to receiving the reflected light RL, based on the electric charge amount accumulated in the plurality of charge accumulation units. The distance calculation unit 42 calculates the distance to the subject OB in accordance with the calculated delay time.

The distance calculation unit 42 calculates a delay time Td by, for example, the following Equation (1). In addition, in Equation (1), it is assumed that the electric charge amount of a certain amount of fixed pattern noise (FPN) that is included in the electric charge amount accumulated in the charge accumulation units CS1 and CS2 and does not depend on the number of times of integration is the same as the electric charge amount accumulated in the charge accumulation unit CS3.

$$Td = To \times ( Q 2 - Q 3 ) / ( Q 1 + Q 2 - 2 \times Q 3 ) \qquad Equation ( 1 )$$

Here, To is a period during which the optical pulse PO is emitted.

Q1 is the electric charge amount accumulated in the charge accumulation unit CS1.

Q2 is the electric charge amount accumulated in the charge accumulation unit CS2.

Q3 is the electric charge amount accumulated in the charge accumulation unit CS3.

In the short-distance light receiving pixel, the distance calculation unit 42 multiplies the delay time Td obtained by Equation (1) by the speed of light (speed) to calculate a round-trip distance to the subject OB. Then, the distance calculation unit 42 divides the calculated round-trip distance by half to measure the distance to the subject OB.

The measurement control unit 43 controls the timing control unit 41. For example, the measurement control unit 43 sets the number of times of integration and the accumulation time in one frame, and controls the timing control unit 41 such that an image is captured with the set contents.

With such a configuration, in the distance image capturing device 1, the light receiving unit 3 receives the reflected light RL in which the optical pulse PO in the near-infrared wavelength band emitted to the subject OB by the light source unit 2 is reflected by the subject OB, and the distance image processing unit 4 calculates the distance to the subject OB and outputs the distance information.

Although FIG. 1 shows the distance image capturing device 1 having a configuration in which the distance image processing unit 4 is provided in the distance image capturing device 1, the distance image processing unit 4 may be a component provided outside the distance image capturing device 1.

In the present embodiment, the distance to the subject is measured by performing a plurality of times of measurement and generating a composite image in which distance images obtained in each measurement are combined. Hereinafter, a case where two times of measurement of a first measurement and a second measurement are performed will be described as an example.

The first measurement is a measurement performed in order to grasp a measurement environment including a measurement space and a situation of the subject OB present in the measurement space. In the first measurement, the pixels 321 are driven such that a relatively wide range from a short distance to a long distance is the measurement range.

The distance image capturing device 1 performs measurement by, for example, a driving method by even odd high dynamic range (eoHDR) driving as the first measurement. The eoHDR driving here is a driving method of dividing a pixel group in the light receiving region 320 into a plurality of groups and driving the pixels 321 such that the number of times of integration is different in each group. This is a driving method used for measuring both subjects in a situation in which the subjects are present at both the short distance and the long distance in the measurement space, or in a situation in which a subject having a high reflectivity and a subject having a low reflectivity are present at the similar distance, and the like. A specific driving method for performing the eoHDR driving will be described in detail later.

In addition, the distance image capturing device 1 may perform the first measurement by combining the above-described eoHDR driving and the driving method by depth high dynamic range (dHDR) driving. The dHDR driving here is a driving method of driving the pixels 321 such that the number of times of receiving the reflected light RL from the subject at the long distance is larger than the number of times of receiving the reflected light RL from the subject at the short distance. This is a driving method that suppresses an increase in distance noise relatively even if the amount of light is attenuated by receiving more of the reflected light RL arriving from the subject at the long distance, and improves the measurement accuracy in a depth direction. A specific driving method for performing the dHDR driving will be described in detail later.

The second measurement is measurement for enabling the distance to the adjustment target object AOB to be accurately calculated. The adjustment target object AOB is a subject selected as a target object for distance measurement with high accuracy among subjects present in the measurement space based on a measurement result of the first measurement. For example, in a case where the distance image capturing device 1 is used for person detection, the adjustment target object AOB is a human present in a space to be measured. By accurately calculating the distance to the adjustment target object AOB, the distance to the detection target such as a person can be accurately measured, and the detection accuracy can be improved.

The distance image capturing device 1 performs measurement by a driving method by normal driving as the second measurement, for example. The normal driving here is a driving method of sequentially accumulating electric charges in the plurality of charge accumulation units CS1 to CS4 provided in the pixel 321. In addition, the distance image capturing device 1 performs the range shift driving in the normal driving. The range shift driving is to move (shift) a measurable range. For example, in the distance image capturing device 1 of the present embodiment, in a case where the range shift amount is set to 0 (zero), it is assumed that 0 [m] to 8 [m] is the measurement range. In this case, for example, by setting the range shift amount corresponding to 2 [m], 2 [m] to 10 [m] are the measurement range. A specific method of performing the range shift driving will be described in detail later.

The distance image capturing device 1 calculates the number of times of integration of the second measurement such that the pixel signal corresponding to the charge accumulation unit CS of the pixel 321 that receives the reflected light RL arriving from the adjustment target object AOB does not become saturated and the SN ratio that is a signal value equal to or larger than a threshold value can be secured.

Further, the distance image capturing device 1 calculates the range shift amount such that the charge accumulation unit CS of the pixel 321 that receives the reflected light RL arriving from the adjustment target object AOB is less likely to be affected by the flare.

For example, it is assumed that the subject at a distance of 4 m is selected as the adjustment target object AOB as a result of the first measurement. In this case, when 0 (zero) is set as the range shift amount and 0 [m] to 8 [m] is set as the measurement range, the adjustment target object AOB can be measured. However, in a case where the subject is included at the short distance of about 0 [m] to 2 [m], reflected light from the subject at the short distance may become flare and may be a factor of decreasing the distance accuracy to the adjustment target object AOB.

As a countermeasure, in the present embodiment, the range shift amount is set such that the reflected light arriving from the subject at the short distance is not received, that is, the subject at the short distance is not included in the measurement range. For example, in a case where the adjustment target object AOB is present at a distance of 4 m, the distance image capturing device 1 sets, for example, the range shift amount corresponding to 3 [m] such that the subject at the short distance is not included in the measurement range in consideration of a possibility that the adjustment target object AOB is a moving object, and sets 3 [m] to 11 [m] as the measurement range of the second measurement.

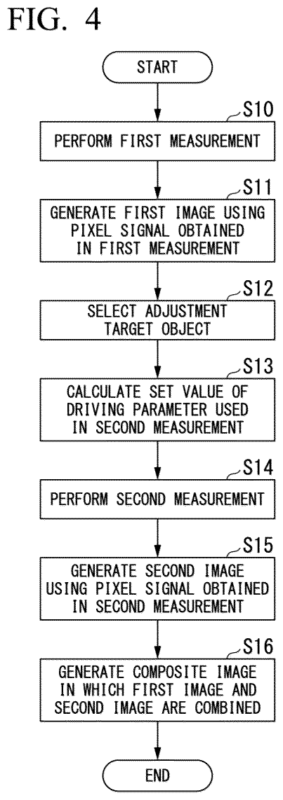

Here, a flow of processing performed by the distance image capturing device 1 will be described with reference to FIG. 4. FIG. 4 is a flowchart showing the flow of processing performed by the distance image capturing device 1 of the embodiment.

First, the distance image capturing device 1 performs the first measurement (step S10). The distance image capturing device 1 performs the first measurement using at least the driving method by the eoHDR driving. The distance image capturing device 1 may perform the first measurement by combining each of the driving methods of the eoHDR driving and the dHDR driving.

Next, the distance image capturing device 1 generates the first image using the pixel signals obtained in the first measurement (step S11). The first image may be a depth image, an infrared (IR) image, or both images, and may be any image as long as the image is generated using at least the pixel signal obtained by the first measurement. The depth image here is a distance image, and is an image in which a depth value (depth) is indicated as a pixel value. The depth value can be calculated using Equation (1). In addition, the IR image here is an image in which the amount of infrared lights (optical pulses emitted by the light source device 21) received by the pixel 321 is shown as the pixel value.

Next, the distance image capturing device 1 selects the adjustment target object AOB from the subject imaged in the first distance image (step S12). For example, in a case where the detection target (for example, a moving object such as a human) is detected by applying an image processing technology to the IR image and performing, for example, object recognition in the image, the distance image capturing device 1 sets the detection target as the adjustment target object AOB.

Next, the distance image capturing device 1 calculates the set value of the driving parameter used in the second measurement (step S13). The driving parameters here are the number of times of integration and the range shift amount.

The distance image capturing device 1 extracts the amount of infrared light received by each of the pixels 321 corresponding to the adjustment target object AOB based on the pixel value of the adjustment target object AOB selected in step S12. The distance image capturing device 1 calculates a representative value, for example, a maximum value, calculated by using a statistical method for each of the extracted amounts of light as the amount of light of the reflected light of the adjustment target object AOB received in the first measurement. The distance image capturing device 1 calculates the number of times of integration as the driving parameter in the second measurement based on the calculated amount of light and the number of times of integration in the first measurement. The distance image capturing device 1 calculates the number of times of integration of the second measurement such that the pixel signal of the pixel 321 corresponding to the adjustment target object AOB is not saturated and the SN ratio that is the signal value equal to or larger than the threshold value can be secured.

In addition, the distance image capturing device 1 calculates a depth value of each pixel corresponding to the adjustment target object AOB in the depth image generated based on the pixel signal obtained in the first measurement, based on the pixel value of the adjustment target object AOB selected in step S12. The distance image capturing device 1 calculates a representative value calculated by using a statistical method, for example, a most frequent value, an average value, the minimum value, or the like for each calculated distance as the distance to the adjustment target object AOB. The distance image capturing device 1 calculates the range shift amount of the second measurement such that the adjustment target object AOB is included in the measurable range and the reflected light arriving from the subject that is in the short distance that causes the flare is not received, based on the calculated distance.

Next, the distance image capturing device 1 performs the second measurement (step S14). The distance image capturing device 1 performs the second measurement with the driving parameter calculated in step S13. The distance image capturing device 1 generates the second image using the pixel signals obtained in the second measurement (step S15). The second image is a depth image (distance image). The distance image capturing device 1 generates a composite image in which the first image and the second image are combined (step S16). The pixel value (distance value) of the composite image indicates the distance to the subject. Accordingly, the distance to the subject can be measured. Specific processing of generating the composite image will be described in detail later.

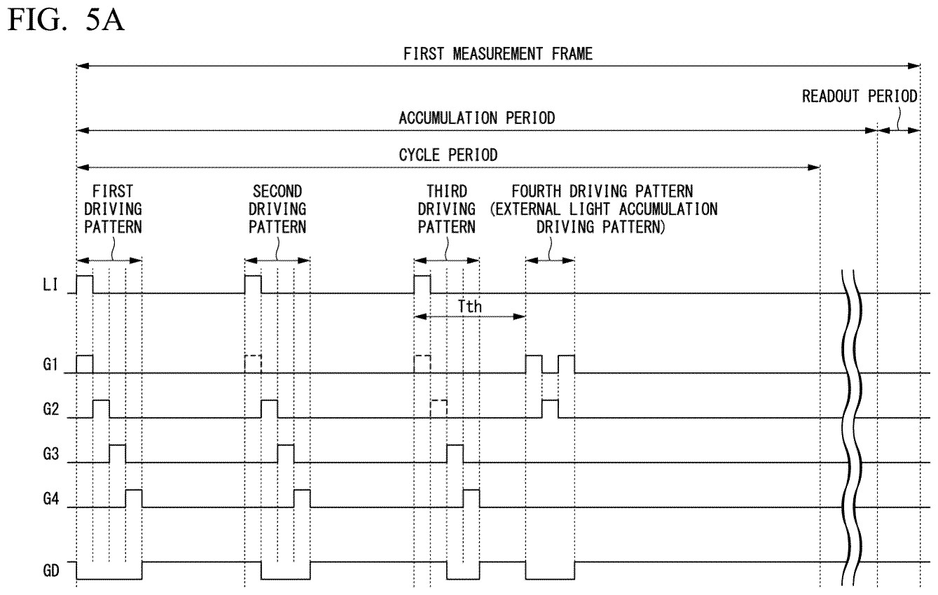

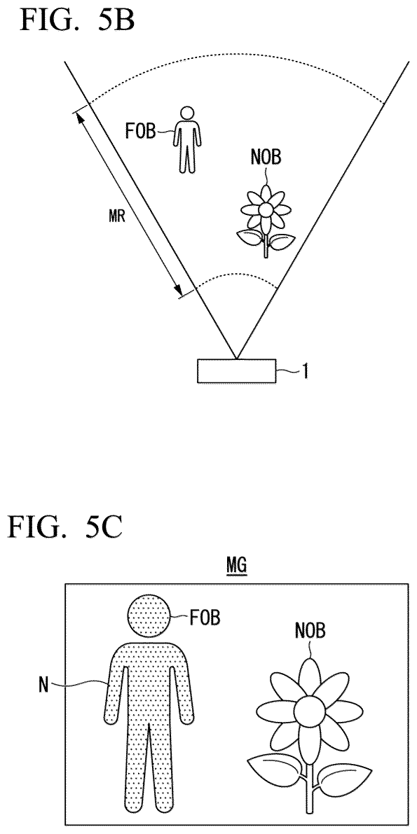

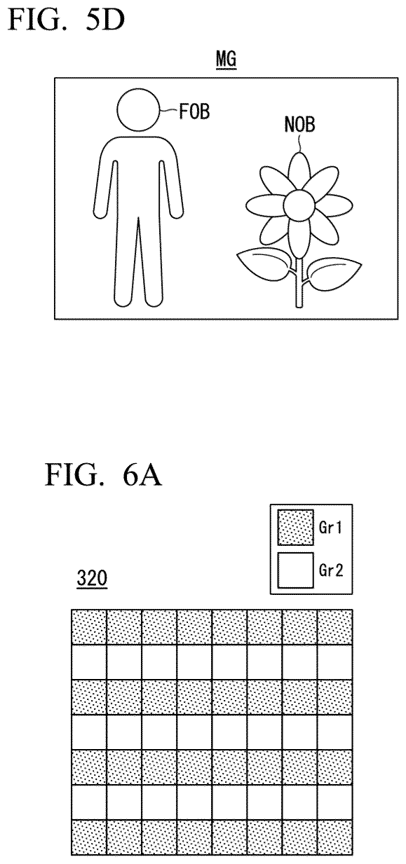

Here, the dHDR driving will be described with reference to FIGS. 5A to 5D. FIGS. 5A to 5D are a diagram showing the dHDR driving as a driving method performed by the distance image capturing device 1 of the embodiment.

FIG. 5A shows an example of a timing chart of driving the pixel 321 by the driving method using the dHDR driving.

In this drawing, timing charts of elements corresponding to respective items of “LI”, “G1” to “G4”, and “GD” are shown. The term “LI” indicates emission timing of the optical pulse PO, light is emitted when the optical pulse PO is in an on-state, and no light is emitted when the optical pulse PO is in an off-state. The terms “G1” to “G4” indicate accumulation timing of the readout gate transistors G1 to G4, the electric charges are accumulated when the readout gate transistors G1 to G4 are in the on-state, and the electric charges are not accumulated when the readout gate transistors G1 to G4 are in the off-state. The term “GD” indicates driving timing of the drain gate transistor GD, and the electric charges are discharged when the drain gate transistor GD is in the on-state, and the electric charges are not discharged when the drain gate transistor GD is in the off-state.

In the dHDR driving, a plurality of driving patterns (first driving pattern to fourth driving pattern) are executed in one frame.

The first driving pattern is a reference driving pattern, and is a driving pattern in which the electric charge is sequentially accumulated in all of the four charge accumulation units CS at an accumulation timing synchronized with the emission timing. In the first driving pattern, the drain gate transistor GD is in the off-state at the same timing as the emission timing at which the optical pulse PO is emitted, and the readout gate transistors G1 to G4 are in the on-state in order.

Specifically, in the first driving pattern, the timing control unit 41 turns the drain gate transistor GD to the off-state and turns the readout gate transistor G1 to the on-state at the emission timing via the pixel driving circuit 322. The readout gate transistor G1 is in the on-state, and then the readout gate transistor G1 is in the off-state after a specific accumulation time (for example, the same time as the emission time at which the optical pulse PO is emitted) elapses. The readout gate transistor G2 is in the on-state at a timing at which the readout gate transistor G1 is in the off-state. The readout gate transistor G2 is in the on-state, and then the readout gate transistor G2 is in the off-state after the accumulation time To elapses. At a timing at which the readout gate transistor G2 is in the off-state, the readout gate transistor G3 is in the on-state. The readout gate transistor G3 is in the on-state, and then the readout gate transistor G3 is in the off-state after the accumulation time To elapses. At a timing at which the readout gate transistor G3 is in the off-state, the readout gate transistor G4 is in the on-state. The readout gate transistor G4 is in the on-state, and then the readout gate transistor G4 is in the off-state, and the drain gate transistor GD is in the on-state after the accumulation time To elapses.

The second driving pattern is a driving pattern in which the accumulation timing of each of the readout gate transistors G1 to G4 with respect to the emission timing is set to the same timing as that of the first driving pattern, and the readout gate transistor G1 is not in the on-state. That is, the second driving pattern is a driving pattern in which the charge accumulation unit CS1 corresponding to the readout gate transistor G1 does not accumulate the electric charge with respect to the first driving pattern. In the second driving pattern, the driving of accumulating the electric charge in the charge accumulation units CS2 to CS4 in order is repeatedly executed a predetermined number of times of integration N.

Specifically, in the second driving pattern, the timing control unit 41 causes the drain gate transistor GD to be in the off-state and causes the readout gate transistor G2 to be in the on-state after the accumulation time To elapses from the emission timing, via the pixel driving circuit 322. The readout gate transistor G2 is in the on-state, and then the readout gate transistor G2 is in the off-state after the accumulation time To elapses. At a timing at which the readout gate transistor G2 is in the off-state, the readout gate transistor G3 is in the on-state. The readout gate transistor G3 is in the on-state, and then the readout gate transistor G3 is in the off-state after the accumulation time To elapses. At a timing at which the readout gate transistor G3 is in the off-state, the readout gate transistor G4 is in the on-state. The readout gate transistor G4 is in the on-state, and then the readout gate transistor G4 is in the off-state, and the drain gate transistor GD is in the on-state after the accumulation time To elapses.

The third driving pattern is a driving pattern in which the accumulation timing of each of the readout gate transistors G1 to G4 with respect to the emission timing is set to the same timing as that of the first driving pattern, and the readout gate transistors G1 and G2 are not set to the on-state. That is, the third driving pattern is a driving pattern in which the charge accumulation units CS1 and CS2 corresponding to the readout gate transistor G1 and G2 do not accumulate the electric charge with respect to the first driving pattern. In the third driving pattern, the driving of sequentially accumulating the electric charge in the charge accumulation units CS3 to CS4 is set as a third accumulation period, and the driving corresponding to the third accumulation period is repeatedly executed a predetermined number of times of integration N.

Specifically, in the third driving pattern, the timing control unit 41 causes the drain gate transistor GD to be in the off-state and causes the readout gate transistor G3 to be in the on-state after the accumulation time To×2 elapses from the emission timing, via the pixel driving circuit 322. The readout gate transistor G3 is in the on-state, and then the readout gate transistor G3 is in the off-state after the accumulation time To elapses. At a timing at which the readout gate transistor G3 is in the off-state, the readout gate transistor G4 is in the on-state. The readout gate transistor G4 is in the on-state, and then the readout gate transistor G4 is in the off-state, and the drain gate transistor GD is in the on-state after the accumulation time To elapses.

After the reflected light reception time Tth elapses from the time point when the third driving pattern is started, the fourth driving pattern is executed. In the fourth driving pattern, the charge accumulation unit CS1 accumulates the electric charge twice, and the charge accumulation unit CS2 accumulates the electric charge once.

Specifically, in the fourth driving pattern, the timing control unit 41 causes the drain gate transistor GD to be in the off-state and causes the readout gate transistor G1 to be in the on-state via the pixel driving circuit 322. The readout gate transistor G1 is in the on-state, and then the readout gate transistor G1 is in the off-state after the accumulation time To elapses. The readout gate transistor G2 is in the on-state at a timing at which the readout gate transistor G1 is in the off-state. The readout gate transistor G2 is in the on-state, and then the readout gate transistor G2 is in the off-state after the accumulation time To elapses. The readout gate transistor G1 is in the on-state at a timing at which the readout gate transistor G2 is in the off-state. The readout gate transistor G1 is in the on-state, and then the readout gate transistor G1 is in the off-state, and the drain gate transistor GD is in the on-state after the accumulation time To elapses.

In the fourth driving pattern, the electric charges corresponding only to the fixed pattern noise is accumulated without emitting the optical pulse PO. That is, in the fourth driving pattern, only the fixed pattern noise component is accumulated. Accordingly, the same amount of the electric charge amount corresponding to the fixed pattern noise component can be accumulated in all the charge accumulation units CS included in the pixel 321.

In the dHDR driving, the number of times of accumulation of the electric charge corresponding to the reflected light in each of the charge accumulation units CS1 to CS4 included in the pixel 321 is different in one cycle period. The number of times of accumulation of the electric charge is controlled to be larger in the charge accumulation unit (for example, the charge accumulation units CS3 and CS4) that accumulates the electric charge of the reflected light RL arriving from the long distance than in the charge accumulation unit (for example, the charge accumulation unit CS1) that accumulates the electric charge of the reflected light RL arriving from the subject NOB at the short distance. As a result, the distance noise in the depth direction can be reduced as compared with the normal driving. In the normal driving, a driving method in which the first driving pattern of FIG. 5A is repeatedly performed in one frame is used.

FIG. 5B schematically shows an example in which a plurality of subjects having different distances, the subject FOB present at the long distance, and the subject NOB present at the short distance are present in the measurement space of the distance image capturing device 1.

FIG. 5C schematically shows an example of the distance image MG obtained by the normal driving.

As shown in FIG. 5C, in the normal driving, the accuracy of the depth value of the subject FOB at the long distance is decreased, and it is difficult to suppress the distance noise N.

FIG. 5D schematically shows an example of the distance image MG obtained by the dHDR driving.

As shown in FIG. 5D, in the dHDR driving, the accuracy of the depth value of the subject FOB at the long distance is improved as compared with the normal driving, and the distance noise can be suppressed.

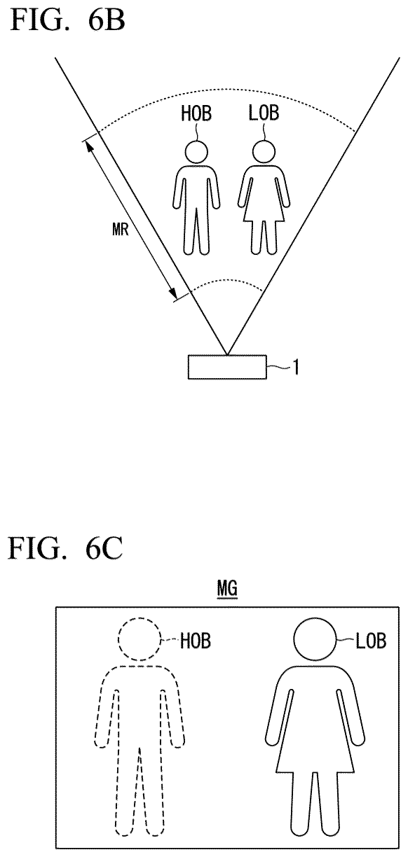

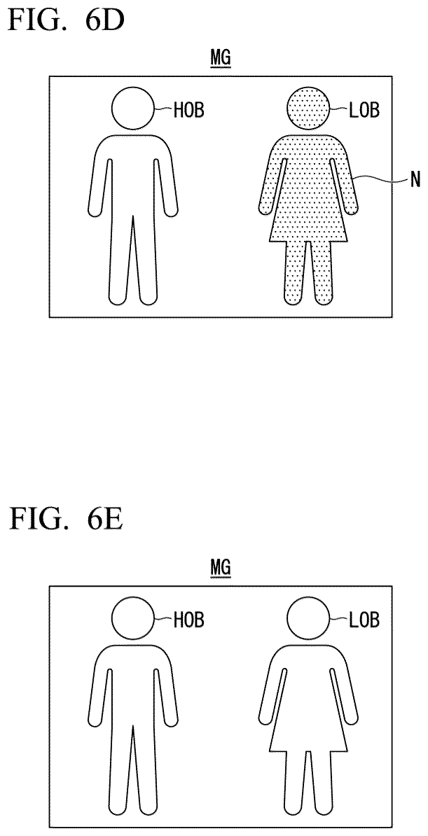

Here, the eoHDR driving will be described with reference to FIGS. 6A to 6E. FIGS. 6A to 6E are a diagram showing the eoHDR driving as the driving method performed by the distance image capturing device 1 of the embodiment.

The eoHDR driving is a driving method in which each of the pixels 321 provided in the light receiving region 320 is classified into at least two groups and is driven such that the number of times of integration of each of the groups is different.

In a measurement environment in which subjects having different reflectivities are present at the same distance, the intensity of the reflected light RL that arrives from the subject having a high reflectivity is higher than the intensity of the reflected light RL that arrives from the subject having a low reflectivity. In such a measurement environment, when the number of times of integration is large, the pixel signal corresponding to the subject having a high reflectivity is likely to be saturated, and when the pixel signal is saturated, the distance cannot be measured. On the other hand, when the number of times of integration is small, the pixel signal corresponding to the subject having the low reflectivity has a small value, and noise relatively larger than the signal value is included, and the measurement accuracy is decreased. As a countermeasure, the pixels are classified into two groups, and the pixels are driven such that the number of times of integration is different for each group.

As the classification of the group, for example, in the pixel array arranged in a two-dimensional matrix in the light receiving region 320, an even row and an odd row in the horizontal direction can be used.

In this case, the driving is performed such that the number of times of integration per frame is different between the pixel group arranged in the even row and the pixel group arranged in the odd row.

In a case where only the eoHDR driving is driven alone without combining the eoHDR driving and the dHDR driving, normal driving can be employed as the opening and closing timing of each gate (timing at which the charge accumulation unit CS provided in the pixel 321 accumulates the electric charge).

In a case where the eoHDR driving and the dHDR driving are combined to drive the eoHDR driving, the dHDR driving is employed as the opening and closing timing of each gate (the timing at which the charge accumulation unit CS provided in the pixel 321 accumulates the electric charge).

FIG. 6A shows an example of a timing chart in which the pixels 321 are classified into two groups Gr (group Gr1 and Gr2) and driven.

FIG. 6B schematically shows an example in which a plurality of subjects having different reflectivities, the subject HOB having a high reflectivity, and the subject LOB having a low reflectivity are present in the measurement space of the distance image capturing device 1 at the same distance.

FIG. 6C schematically shows an example of the distance image MG obtained in a case where the pixels are not grouped and the driving is performed with a relatively large number of times of integration. In this case, the pixel signal of the subject HOB having the high reflectivity is saturated, and the distance to the subject HOB having the high reflectivity cannot be measured.

FIG. 6D schematically shows an example of the distance image MG obtained in a case where the pixels are not grouped and the driving is performed with a relatively small number of times of integration. In this case, the pixel signal of the subject LOB having the low reflectivity has a small value, noise relatively larger than the signal value is included, and the accuracy of the distance to the subject LOB having the low reflectivity is decreased.

FIG. 6E schematically shows an example of the distance image MG obtained in a case where the pixels are divided into two groups, one group is driven with a relatively large number of times of integration, and the other group is driven with a relatively small number of times of integration. In this case, the distance to the subject HOB having the high reflectivity can be measured, and the decrease in measurement accuracy of the subject LOB having the low reflectivity can be suppressed.

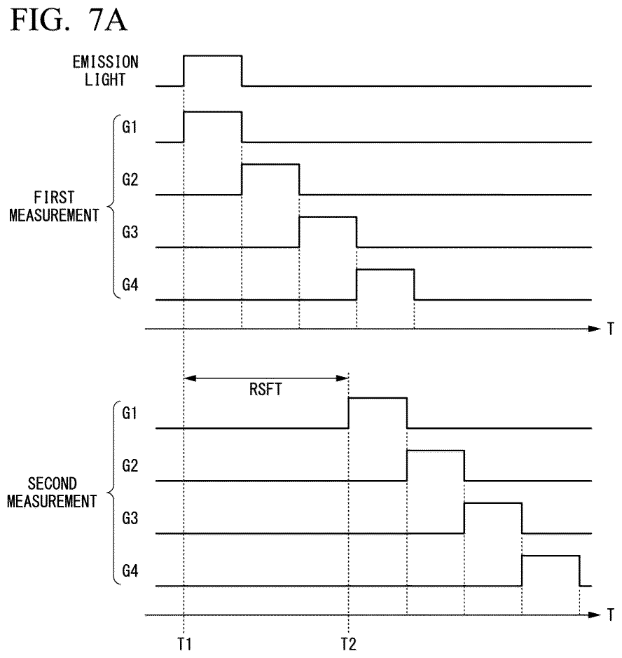

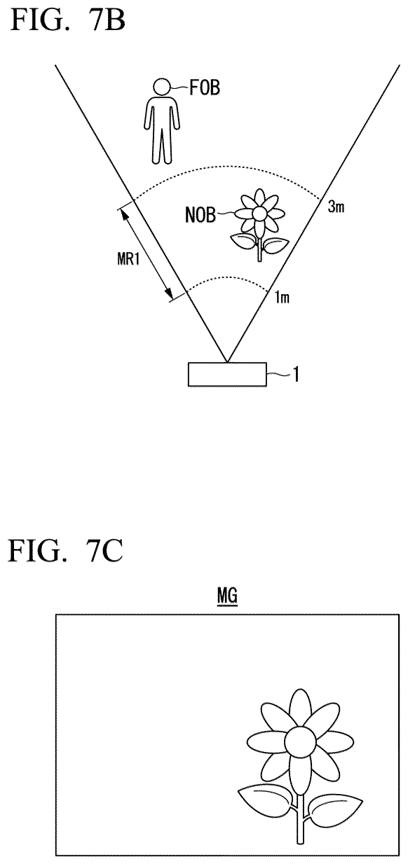

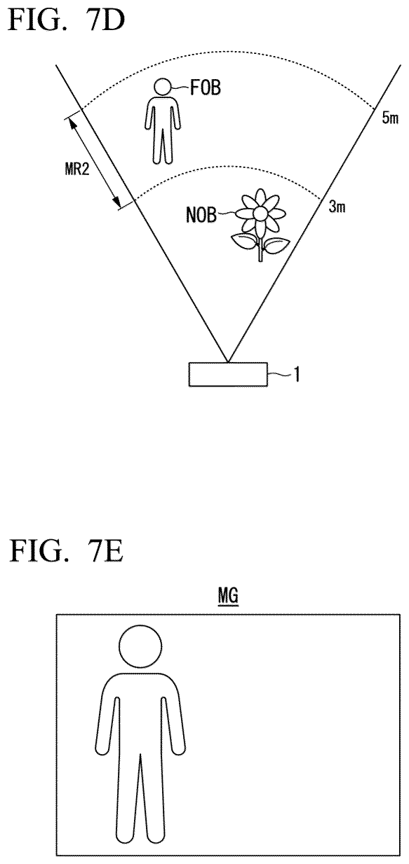

Here, the range shift driving will be described with reference to FIGS. 7A to 7E. FIGS. 7A to 7E are a diagram showing the range shift driving as the driving method performed by the distance image capturing device 1 of the embodiment. FIG. 7A shows timing charts of the first measurement and the second measurement with respect to an emission timing of the emission of the optical pulse PO.

In this drawing, an example in which both the first measurement and the second measurement are driven by the normal driving is shown. In the first measurement, a timing chart of the normal driving in which the range shift amount is set to 0 (zero) is shown, and in the second measurement, a timing chart of the normal driving in which the range shift amount RSFT is set is shown.

As shown in the upper part of FIG. 7A, in the first measurement, since the range shift amount is set to 0 (zero), the emission timing of the emission light, which is the optical pulse PO, and the opening and closing timing of the gate (readout gate transistor G1) of the charge accumulation unit CS1 are controlled to be the same timing. Specifically, at time T1 which is a timing at which the emission of the emission light is started, the gate (readout gate transistor G1) of the charge accumulation unit CS1 is set to High, and the gate is controlled to be in the on-state. Thereafter, at a timing at which the emission of the emission light is ended, the gate (readout gate transistor G1) of the charge accumulation unit CS1 is set to Low, and the gate is controlled to be in the off-state.

On the other hand, in the second measurement, since the range shift amount is set to RSFT, the opening and closing timing of the gate (readout gate transistor G1) of the charge accumulation unit CS1 is controlled to be delayed by a time corresponding to the range shift amount RSFT with respect to the emission timing of the emission light which is the optical pulse PO. Specifically, at a time T2 that elapses from a timing at which the emission of the emission light is started by a time corresponding to the range shift amount RSFT, the gate (readout gate transistor G1) of the charge accumulation unit CS1 is set to High, and the gate is controlled to be in the on-state. After a time corresponding to the range shift amount RSFT elapses from a timing at which the emission of the emission light ends, the gate (readout gate transistor G1) of the charge accumulation unit CS1 is set to Low, and the gate is controlled to be in the off-state.

FIGS. 7B and 7D schematically show an example in which a plurality of subjects having different distances, the subject FOB present at the long distance, and the subject NOB present at the short distance are present in the measurement space of the distance image capturing device 1.

FIG. 7B shows a distance measurement range MR1 which is a measurable distance range in a case where the range shift amount is set to 0 (zero). In this drawing, the distance measurement range MR1 is 1 [m] to 3 [m]. In a case where the range shift amount is set to 0 (zero), the subject FOB present at a distance of about 4 [m] is not included in the distance measurement range MR1.

FIG. 7C shows an example of the distance image MG in a case where the range shift amount is set to 0 (zero). As shown in FIG. 7C, in a case where the range shift amount is set to 0 (zero), the distance image MG is an image in which only the distance to the subject NOB is shown, and is an image in which the distance to the subject FOB is not shown.

FIG. 7D shows a distance measurement range MR2 which is a measurable distance range in a case where the range shift amount RSFT is set. In this drawing, the distance measurement range MR2 is 3 [m] to 5 [m]. In a case where the range shift amount RSFT is set, the subject NOB present at a distance of about 1 [m] is not included in the distance measurement range MR2.

FIG. 7E shows an example of the distance image MG in a case where the range shift amount RSFT is set. As shown in FIG. 7E, in a case where the range shift amount RSFT is set, the distance image MG is an image in which only the distance to the subject FOB is shown, and is an image in which the distance to the subject NOB is not shown.

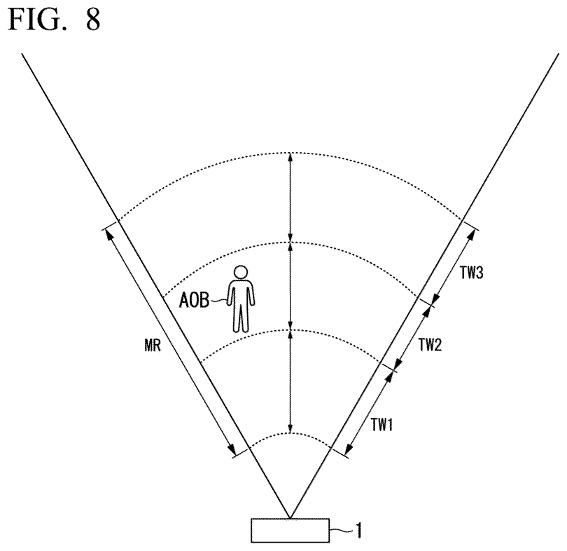

Here, processing of calculating the number of times of integration in the second measurement will be described with reference to FIGS. 8, FIGS. 9A to 9C, FIGS. 10A to 10C, and FIGS. 11A to 11C. FIGS. 8 to 11C are diagrams showing processing of calculating the number of times of integration performed by the distance image capturing device 1 of the embodiment.

FIG. 8 schematically shows a position of the adjustment target object AOB in the measurement space of the distance image capturing device 1. In this drawing, the distance measurement range MR is divided into a plurality of time windows TW (time windows TW1 to TW3).

The time window TW1 is a short distance division, and is a measurement range in a case where the charge accumulation units CS, for example, the charge accumulation units CS1 and CS2, which accumulate the electric charge at a relatively early timing with respect to the emission timing of the optical pulse PO, accumulate the electric charge corresponding to the reflected light RL.

The time window TW2 is a medium distance division, and is a measurement range in a case where the charge accumulation units CS, for example, the charge accumulation units CS2 and CS3, which accumulate the electric charge at a medium timing with respect to the emission timing of the optical pulse PO, accumulate the electric charge corresponding to the reflected light RL.

The time window TW3 is a long distance division, and is a measurement range in a case where the charge accumulation units CS, for example, the charge accumulation units CS3 and CS4, which accumulate the electric charge at a relatively late timing with respect to the emission timing of the optical pulse PO, accumulate the electric charge corresponding to the reflected light RL.

In this drawing, it is shown that, as a result of performing the first measurement, the subject in the medium distance division corresponding to the time window TW2 is selected as the adjustment target object AOB.

In the present embodiment, the number of times of integration in the second measurement is set such that the electric charge corresponding to the reflected light RL that arrives from the adjustment target object AOB is accumulated in the charge accumulation unit CS without being saturated and is equal to or larger than the threshold value based on the result of performing the first measurement. As a pattern for calculating the number of times of integration, four patterns PTN (patterns PTN1 to PTN4) are assumed. The pattern PTN1 is a pattern in which the distance value to the adjustment target object AOB is divided into the time window TW1. The pattern PTN2 is a pattern in which the distance value to the adjustment target object AOB is divided into the time window TW2. The pattern PTN3 is a pattern in which the distance value to the adjustment target object AOB is divided into the time window TW3. The pattern PTN4 is a pattern in which the adjustment target object AOB is not detected.

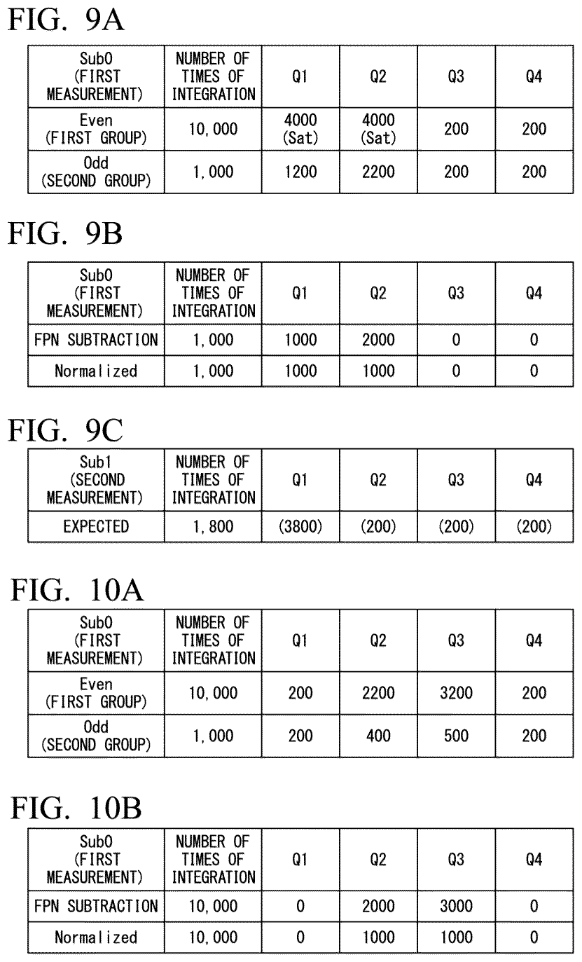

FIGS. 9A to 11C are diagrams showing processing of calculating the number of times of integration to be used in the second measurement in each pattern of the patterns PTN1 to PTN3.

Here, it is assumed that the saturation level of the pixel signal corresponding to the electric charge accumulation amount of the charge accumulation unit CS is 4000 LSB. In addition, it is assumed that the driving in which the eoHDR driving and the dHDR driving are combined is performed in the first measurement, and the normal driving is performed in the second measurement.

In addition, in the dHDR driving of the first measurement, the ratio of the number of times of opening and closing each gate (the number of times of accumulating the reflected light in each charge accumulation unit CS in one frame) is represented by the following Equation (2).

$$Gk 1 : Gk 2 : Gk 3 : Gk 4 = 1 : 2 : 3 : 3 \qquad Equation ( 2 )$$

where:
Gk1 is the number of times that the reflected light is accumulated in the charge accumulation unit CS1 in one frame.
Gk2 is the number of times that the reflected light is accumulated in the charge accumulation unit CS2 in one frame.
Gk3 is the number of times that the reflected light is accumulated in the charge accumulation unit CS3 in one frame.
Gk4 is the number of times that the reflected light is accumulated in the charge accumulation unit CS4 in one frame.

FIGS. 9A to 9C show a diagram showing processing of calculating the number of times of integration used in the second measurement in the pattern PTN1.

FIG. 9A shows an example of a measurement result in Sub0 (first measurement). In this drawing, the number of times of integration per unit frame in Even (first group) is 10000 times. The number of times of integration per unit frame in the Odd (second) group is 1000 times.

In the first group, the pixel signals corresponding to the electric charge amounts Q1 to Q4 accumulated in the charge accumulation units CS1 to CS4 are 4000 LSB, 4000 LSB, 200 LSB, and 200 LSB. Among these, 4000 LSB, which is the pixel signal corresponding to the electric charge amounts Q1 and Q2 accumulated in the charge accumulation units CS1 and CS2, is a saturated value.

In the second group, the pixel signals corresponding to the electric charge amounts Q1 to Q4 accumulated in the charge accumulation units CS1 to CS4 are 1200 LSB, 2200 LSB, 200 LSB, and 200 LSB.

FIG. 9B shows an example in which FPN subtraction processing of subtracting a fixed pattern noise (FPN) component from the measurement result in Sub0 (first measurement) is performed, and normalization processing (Normalized) is performed according to the number of times of opening and closing the gate for the subtracted value.

Here, as shown in FIG. 9A, in the first measurement, the pixel signals of the first group are saturated. Therefore, the distance image processing unit 4 performs the FPN subtraction processing and the normalization processing by using the pixel signals of the pixels of the second group.

The distance image processing unit 4 assumes that the fixed pattern noise (FPN) component is 200 LSB from the pixel signals shown in FIG. 9A. In this case, in the second group, the pixel signals after the FPN subtraction processing (the pixel signals corresponding to the electric charge amounts Q1 to Q4 corresponding to the reflected light RL accumulated in the charge accumulation units CS1 to CS4) are 1000 LSB, 2000 LSB, 0 LSB, and 0 LSB.

When this is normalized by the number of times of opening and closing of each gate in the dHDR driving of the first measurement, the pixel signals corresponding to the electric charge amounts Q1 to Q4 corresponding to the reflected light RL accumulated in the charge accumulation units CS1 to CS4 are 1000 LSB, 1000 LSB, 0 LSB, and 0 LSB.

FIG. 9C shows values of the pixel signals predicted from the number of times of integration in Sub1 (second measurement).

The distance image processing unit 4 calculates the number of times of integration such that the electric charge is accumulated as much as possible (for example, the threshold value 3500 LSB or more) in a range in which the electric charge amount is not saturated, that is, does not exceed 4000 LSB, based on the normalized pixel signal shown in FIG. 9B.

Here, the distance image processing unit 4 calculates the number of times of integration such that the electric charge amount is not saturated, on the premise that most of the electric charge corresponding to the reflected light RL arriving from the adjustment target object AOB is accumulated in the charge accumulation unit CS1 by the range shift driving to be described later.

Here, in FIG. 9B, it is shown that each of the pixel signals corresponding to the electric charge amounts Q1 and Q2 is 1000 LSBs, and a total of 2000 LSBs of the pixel signals corresponding to the reflected light RL is obtained by driving the number of times of integration of 1000 times.

In this drawing, the distance image processing unit 4 calculates the number of times of integration as 1800 times. This is obtained by calculating the number of times of integration as 1800 times (=3600 LSB/2000 LSB×1000 times) such that the total (2000 LSB) of the pixel signals corresponding to the reflected light RL is a value (for example, 3600 LSB) that is not saturated in a case where the total is accumulated in one charge accumulation unit CS1.

In this case, the pixel signals corresponding to the electric charge amounts Q1 to Q4 expected to be accumulated in the charge accumulation units CS1 to CS4 are 3800 LSB, 200 LSB, 200 LSB, and 200 LSB. This is because the signal corresponding to the fixed pattern noise (FPN) that does not depend on the number of times of integration is 200 LSB as shown in FIG. 9A, and thus, the signal amount of 200 LSB corresponding to the fixed pattern noise (FPN) is added to the pixel signals corresponding to the electric charge amounts Q1 to Q4.

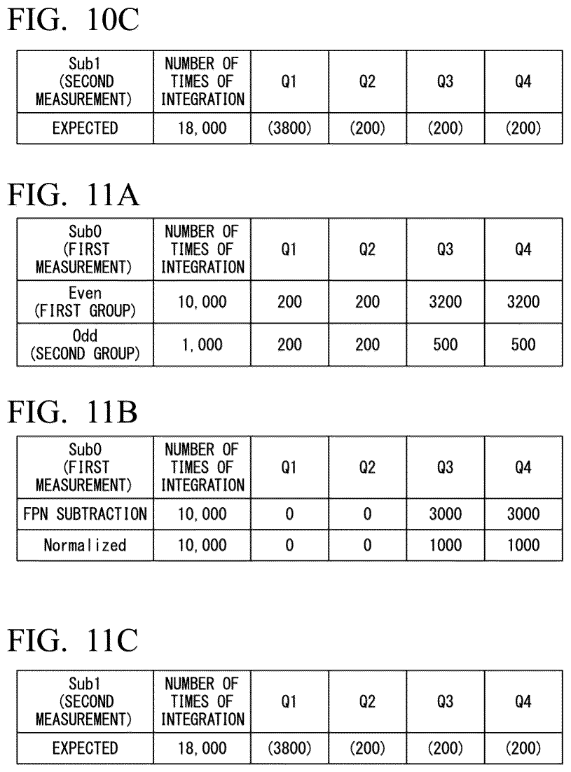

FIGS. 10A to 10C show a diagram showing processing of calculating the number of times of integration to be used in the second measurement in the pattern PTN2.

FIG. 10A shows an example of a measurement result in Sub0 (first measurement). In this drawing, the number of times of integration per unit frame in Even (first group) is 10000 times. The number of times of integration per unit frame in the Odd (second) group is 1000 times.

In the first group, the pixel signals corresponding to the electric charge amounts Q1 to Q4 accumulated in the charge accumulation units CS1 to CS4 are 200 LSB, 2200 LSB, 3200 LSB, and 200 LSB.

In the second group, the pixel signals corresponding to the electric charge amounts Q1 to Q4 accumulated in the charge accumulation units CS1 to CS4 are 200 LSB, 400 LSB, 500 LSB, and 200 LSB.

FIG. 10B shows an example in which the FPN subtraction processing is performed from the measurement result in Sub0 (first measurement) and the normalization processing is performed according to the number of times of opening and closing of the gate.

Here, as shown in FIG. 10A, in the first measurement, the pixel signals of the pixels belonging to the first group are not saturated. Therefore, the distance image processing unit 4 performs the FPN subtraction processing and the normalization processing by using the pixel signals of the pixels of the first group.

In the distance image processing unit 4, it is assumed that the fixed pattern noise (FPN) component is 200 LSB from the pixel signals shown in FIG. 10A. In this case, in the first group, the pixel signals after the FPN subtraction processing (the pixel signals corresponding to the electric charge amounts Q1 to Q4 corresponding to the reflected light RL accumulated in the charge accumulation units CS1 to CS4) are 0 LSB, 2000 LSB, 3000 LSB, and 0 LSB. When this is normalized by the number of times of opening and closing of each gate in the dHDR driving of the first measurement, the pixel signals corresponding to the electric charge amounts Q1 to Q4 corresponding to the reflected light RL accumulated in the charge accumulation units CS1 to CS4 are 0 LSB, 1000 LSB, 1000 LSB, and 0 LSB.

FIG. 10C shows values of pixel signals predicted from the number of times of integration in Sub1 (second measurement).

The distance image processing unit 4 calculates the number of times of integration such that the electric charge is accumulated as much as possible (for example, the threshold value 3500 LSB or more) in a range in which the electric charge amount is not saturated, that is, does not exceed 4000 LSB, based on the normalized pixel signal shown in FIG. 10B.

Here, the distance image processing unit 4 calculates the number of times of integration such that the electric charge amount is not saturated, on the premise that most of the electric charge corresponding to the reflected light RL arriving from the adjustment target object AOB is accumulated in the charge accumulation unit CS1 by the range shift driving to be described later.

Here, in FIG. 10B, it is shown that each of the pixel signals corresponding to the electric charge amounts Q2 and Q3 is 1000 LSBs, and a total of 2000 LSBs of the pixel signals corresponding to the reflected light RL is obtained by driving the number of times of integration of 10000 times.

In this drawing, the distance image processing unit 4 calculates the number of times of integration as 18000. This is obtained by calculating the number of times of integration as 18000 times (=3600 LSB/2000 LSB×10000 times) such that the total (2000 LSB) of the pixel signals corresponding to the reflected light RL is a value (for example, 3600 LSB) that is not saturated in a case where the total is accumulated in one charge accumulation unit CS1.

In this case, the pixel signals corresponding to the electric charge amounts Q1 to Q4 expected to be accumulated in the charge accumulation units CS1 to CS4 are 3800 LSB, 200 LSB, 200 LSB, and 200 LSB. This is because the signal corresponding to the fixed pattern noise (FPN) that does not depend on the number of times of integration is 200 LSB as shown in FIG. 10A, and thus, the signal amount of 200 LSB corresponding to the fixed pattern noise (FPN) is added to the pixel signals corresponding to the electric charge amounts Q1 to Q4.

FIG. 11 shows a diagram showing processing of calculating the number of times of integration to be used in the second measurement in the pattern PTN3.

FIG. 11A shows an example of a measurement result in Sub0 (first measurement). In this drawing, the number of times of integration per unit frame in Even (first group) is 10000 times. The number of times of integration per unit frame in the Odd (second) group is 1000 times.

In the first group, the pixel signals corresponding to the electric charge amounts Q1 to Q4 accumulated in the charge accumulation units CS1 to CS4 are 200 LSB, 200 LSB, 3200 LSB, and 3200 LSB.

In the second group, the pixel signals corresponding to the electric charge amounts Q1 to Q4 accumulated in the charge accumulation units CS1 to CS4 are 200 LSB, 200 LSB, 500 LSB, and 500 LSB.

FIG. 11B shows an example in which the FPN subtraction processing is performed from the measurement result in Sub0 (first measurement) and the normalization processing is performed according to the number of times of opening and closing of the gate.

Here, as shown in FIG. 11A, in the first measurement, the pixel signals of the first group are not saturated. Therefore, the distance image processing unit 4 performs the FPN subtraction processing and the normalization processing by using the pixel signals of the pixels of the first group.

In the distance image processing unit 4, it is assumed that the fixed pattern noise (FPN) component is 200 LSB from the pixel signals shown in FIG. 11A. In this case, in the first group, the pixel signals after the FPN subtraction processing (the pixel signals corresponding to the electric charge amounts Q1 to Q4 corresponding to the reflected light RL accumulated in the charge accumulation units CS1 to CS4) are 0 LSB, 0 LSB, 3000 LSB, and 3000 LSB. When this is normalized by the number of times of opening and closing of each gate in the dHDR driving of the first measurement, the pixel signals corresponding to the electric charge amounts Q1 to Q4 corresponding to the reflected light RL accumulated in the charge accumulation units CS1 to CS4 are 0 LSB, 0 LSB, 1000 LSB, and 1000 LSB.

FIG. 11C shows the values of the pixel signals predicted from the number of times of integration in Sub1 (second measurement).

The distance image processing unit 4 calculates the number of times of integration such that the electric charge is accumulated as much as possible (for example, the threshold value 3500 LSB or more) in a range in which the electric charge amount is not saturated, that is, does not exceed 4000 LSB, based on the normalized pixel signal shown in FIG. 11B.

Here, the distance image processing unit 4 calculates the number of times of integration such that the electric charge amount is not saturated, on the premise that most of the electric charge corresponding to the reflected light RL arriving from the adjustment target object AOB is accumulated in the charge accumulation unit CS1 by the range shift driving to be described later.

Here, in FIG. 11B, it is shown that each of the pixel signals corresponding to the electric charge amounts Q3 and Q4 is 1000 LSBs, and a total of 2000 LSBs of the pixel signals corresponding to the reflected light RL is obtained by driving the number of times of integration of 10000 times.

In this drawing, the distance image processing unit 4 calculates the number of times of integration as 18000. This is obtained by calculating the number of times of integration as 18000 times (=3600 LSB/2000 LSB×10000 times) such that the total (2000 LSB) of the pixel signals corresponding to the reflected light RL is a value (for example, 3600 LSB) that is not saturated in a case where the total is accumulated in one charge accumulation unit CS1.

In this case, the pixel signals corresponding to the electric charge amounts Q1 to Q4 expected to be accumulated in the charge accumulation units CS1 to CS4 are 3800 LSB, 200 LSB, 200 LSB, and 200 LSB.

In the pattern PTN4, in a case where the adjustment target object AOB is not detected, the distance image processing unit 4 does not proceed to the second measurement, and repeatedly executes the first measurement until the adjustment target object AOB is detected.

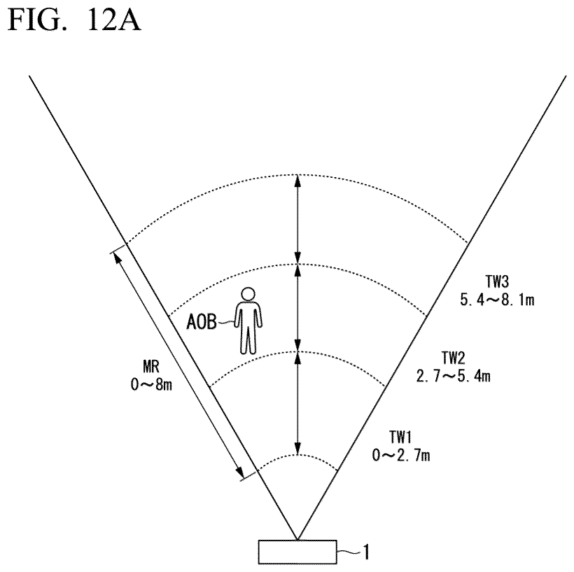

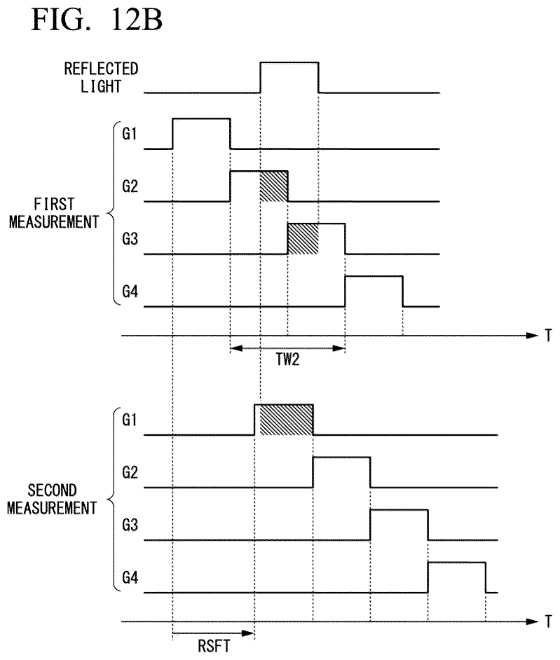

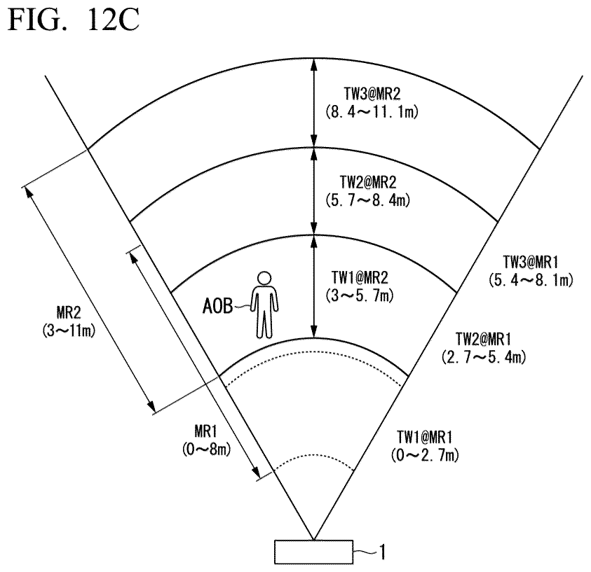

Here, processing of calculating the range shift amount will be described with reference to FIGS. 12A to 12C. FIGS. 12A to 12C are a diagram showing processing of calculating the range shift amount performed by the distance image capturing device 1 of the embodiment.

FIG. 12A schematically shows the position of the adjustment target object AOB in the measurement space of the distance image capturing device 1, as in FIG. 8. In this drawing, the distance measurement range MR is in a range of approximately 0 [m] to 8 [m], and each of the time windows TW1 to TW3 is in a range of 0 [m] to 2.7 [m], 2.7 [m] to 5.4 [m], and 5.4 [m] to 8.1 [m].

In addition, in this drawing, it is shown that, as a result of performing the first measurement, the subject at a distance of about 4 [m] corresponding to the time window TW2 is selected as the adjustment target object AOB.

FIG. 12B shows a relationship between a reflected light timing at which the reflected light is received and a timing chart of the first measurement and the second measurement. In this drawing, an example of the first driving pattern of the first measurement and the second measurement of the normal driving are shown.

In the first measurement, the electric charges corresponding to the reflected light RL are accumulated in the charge accumulation units CS2 and CS3. On the other hand, in the second measurement, the range shift amount RSFT is set such that the electric charges corresponding to the reflected light RL are accumulated in the charge accumulation units CS1 and CS2.

In this case, it is desirable to set the range shift amount RSFT such that most of the reflected light RL is accumulated in the charge accumulation unit CS1 from the viewpoint of suppressing the flare.

FIG. 12C schematically shows a state in which the measurement range is moved (shifted) from the distance measurement range MR1 in the first measurement to the distance measurement range MR2 in the second measurement by performing the range shift driving in the second measurement.

The distance measurement range MR1 is in a range of about 0 [m] to 8 [m], while the distance measurement range MR2 is in a range of about 3 [m] to 11 [m].

In the first measurement, each of the time windows TW1 to TW3 is in a range of 0 [m] to 2.7 [m], 2.7 [m] to 5.4 [m], and 5.4 [m] to 8.1 [m].

On the other hand, each of the time windows TW1 to TW3 in the second measurement is in a range of 3 [m] to 5.7 [m], 5.7 [m] to 8.4 [m], and 8.4 [m] to 11.1 [m].

For example, in the distance image capturing device 1, it is assumed that the measurement range is moved (shifted) by about 0.3 [m] in a case where the timing at which the charge accumulation unit CS accumulates the electric charge is delayed by 1 [clk]. In this case, in the second measurement, in a case where the measurement range is moved (shifted) by about 3 [m], the number of clocks corresponding to the range shift amount is set to 10. As a result, the measurement range can be moved (shifted) by (0.3 [m/clk]×10 [clk]=) 3 [m].

Here, specific processing of generating the composite image in which the first image and the second image are combined will be described.

The distance image processing unit 4 generates, for example, the IR image based on the pixel signal obtained by the second measurement, applies an image processing technology to the generated IR image, and performs, for example, object recognition in the image to detect the adjustment target object AOB selected in the first measurement. Then, the distance of each pixel is calculated based on the pixel signal obtained by the second measurement, and the distance image indicating the calculated distance for each pixel is generated as the second image.

Here, in the second measurement, since the range shift driving is performed, the distance to the subject at the short distance is not measured, and the subject at the short distance is not imaged in the second image. Therefore, it is possible to suppress the decrease in distance accuracy due to the flare. That is, the distance accuracy of the adjustment target object AOB imaged in the second image can be improved.

Then, the distance image processing unit 4 generates the composite image. It is assumed that the first image and the second image to be combined here are depth images generated based on each of the pixel signals obtained in the first measurement and the second measurement.

The distance image processing unit 4 generates the composite image by overwriting the pixel (the pixel that has received the reflected light from the adjustment target object AOB and the subject that is farther than the adjustment target object AOB) for which the distance is calculated in the second measurement, with respect to the pixel in the first measurement. For a pixel (a pixel that has received reflected light from a subject that is closer than the adjustment target object AOB) for which the distance is not calculated in the second measurement, the distance calculated in the first measurement is used.

Here, in the second measurement, the number of times of integration appropriate for measuring the adjustment target object AOB based on the first measurement is set, and the range shift driving is performed such that the adjustment target object AOB is less likely to be affected by the flare. Therefore, the SN ratio can be increased, and the measurement accuracy can be improved by suppressing the flare. In addition, the distance measurement range can be expanded by performing the range shift driving.

As described above, the distance image capturing device 1 according to the first embodiment includes the light source unit 2, the light receiving unit 3, and the distance image processing unit 4.

The distance image processing unit 4 performs the first measurement and selects the adjustment target object AOB from the subject OB based on the pixel signal (pixel signal corresponding to the electric charge amount accumulated in each of the charge accumulation units CS) obtained by the first measurement. The distance image processing unit 4 performs eoHDR driving in the first measurement. In the eoHDR driving, the pixels are classified into at least two groups in which the number of times of integration for repeating the processing of accumulating the electric charge in each of the charge accumulation units CS is different, and the charge accumulation units CS are driven such that the electric charge is accumulated in each of the charge accumulation units CS in the number of times of integration of each of the groups. The distance image processing unit 4 performs the second measurement. The distance image processing unit 4 calculates the number of times of integration and the range shift amount in the second measurement based on the pixel signal of the pixel 321 corresponding to the adjustment target object AOB in the first measurement, in the second measurement. The distance image processing unit 4 drives the charge accumulation units CS such that the electric charge is accumulated in each of the charge accumulation units CS by the calculated number of times of integration and range shift amount. The distance image processing unit 4 generates the distance image, for example, the composite image based on the pixel signals obtained according to each measurement of the first measurement and the second measurement.

Accordingly, in the distance image capturing device 1 of the embodiment, the number of times of integration appropriate for measuring the adjustment target object AOB based on the first measurement is set, and the range shift driving can be performed such that the adjustment target object AOB is less likely to be affected by the flare. Therefore, the SN ratio can be increased, and the measurement accuracy can be improved by suppressing the flare.

In addition, in the distance image capturing device 1 of the embodiment, the distance image processing unit 4 performs the first measurement by combining the eoHDR driving with the dHDR driving. The distance image processing unit 4 performs driving such that the number of times of reception of the reflected light is larger in the charge accumulation units CS3 and CS4 (the charge accumulation units CS that accumulate the electric charge at the accumulation timing at which the reflected light arriving from the subject at the long distance is received) than in the charge accumulation unit CS1 (the charge accumulation unit CS that accumulates the electric charge at the accumulation timing at which the reflected light arriving from the subject at the short distance is received) among the plurality of charge accumulation units CS included in the pixel 321, as the dHDR driving. Accordingly, in the distance image capturing device 1 of the embodiment, in the first measurement, the amount of the reflected light arriving from the subject at the long distance can be increased, and the SN ratio can be increased to reduce the amount of noise of the relative distance noise.

In addition, in the distance image capturing device 1 of the embodiment, in a case where the pixel signals of the first group are in the saturated state in the first measurement, the distance image processing unit 4 calculates the number of times of integration in the second measurement using the pixel signals of the second group. Accordingly, in the distance image capturing device 1 of the embodiment, even in a case where the pixel signals of the first group are saturated, the number of times of integration in the second measurement can be calculated.

In addition, in the distance image capturing device 1 of the embodiment, in a case where the pixel signals of the first group are not in the saturated state in the first measurement, the distance image processing unit 4 calculates the number of times of integration in the second measurement using the pixel signals of the first group. Accordingly, in the distance image capturing device 1 of the embodiment, in the first measurement, the number of times of integration in the second measurement can be calculated with high accuracy by using the pixel signal having a larger SN ratio.

In addition, in the distance image capturing device 1 of the embodiment, the distance image processing unit 4 performs measurement by the normal driving as the second measurement. The distance image processing unit 4 calculates the range shift amount in the second measurement such that the reflected light arriving from the adjustment target object AOB is received by the charge accumulation unit CS1 (first charge accumulation unit) that receives light at the earliest accumulation timing in the charge accumulation units CS. Accordingly, in the distance image capturing device 1 of the embodiment, the range shift driving can be performed such that the adjustment target object AOB is less likely to be affected by the flare. Here, the distance image processing unit 4 may calculate the range shift amount in the second measurement such that the charge accumulation unit CS2 accumulates less electric charge than the charge accumulation unit CS1. Accordingly, most of the reflected light arriving from the adjustment target object AOB can be received in the charge accumulation unit CS1, and the influence of the flare on the adjustment target object AOB can be further reduced.

All or a part of the distance image capturing device 1 and the distance image processing unit 4 according to the above-described embodiment may be implemented by a computer. In this case, a program for implementing the functions may be recorded on a computer-readable recording medium, and a computer system may read and execute a program recorded on the recording medium to implement the functions. A term “computer system” herein includes an OS and hardware such as a peripheral device. In addition, a term “computer-readable recording medium” refers to a storage device, for example, a portable medium such as a flexible disk, a magneto-optical disk, a ROM, or a CD-ROM, a hard disk built in a computer system, or the like. Furthermore, a term “computer-readable recording medium” may also include a thing that dynamically stores a program for a short period of time, such as a communication line when transmitting a program through a network such as the Internet or a communication line such as a telephone line, and a thing that stores a program for a certain period of time, such as a server or a volatile memory in a computer system that becomes a client in that case. In addition, the program may implement a part of the above-described function, may further implement the above-described functions in combination with a program previously recorded in a computer system, or may be implemented by a programmable logic device such as an FPGA.

Although the embodiments of the present invention have been described in detail above with reference to the drawings, the specific configuration is not limited to these embodiments, and design, device configuration, correction processing, filtering processing, and the like are included within the scope not departing the gist of the present invention.

While preferred embodiments of the invention have been described and illustrated above, it should be understood that these are exemplary examples of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

What is claimed is:

1. A distance image capturing device comprising:
a light source unit that is configured to emit an optical pulse to a measurement space;
a light receiving unit that includes a pixel circuit in which a plurality of pixels, each including a photoelectric conversion element that generates an electric charge in accordance with incident light and a plurality of charge accumulation units that accumulate the electric charge are arranged in a two-dimensional matrix, and a pixel driving circuit which distributes and accumulates the electric charge in each of the charge accumulation units at a predetermined accumulation timing synchronized with an emission timing at which the optical pulse is emitted; and
a distance image processing unit that is configured to calculate a distance to a subject present in the measurement space based on an electric charge amount accumulated in each of the charge accumulation units,
wherein the distance image processing unit
performs a first measurement and a second measurement,
classifies the pixels into at least two groups having different numbers of times of integration for repeating processing of accumulating the electric charge in each of the charge accumulation units in the first measurement, and performs even odd high dynamic range (eoHDR) driving that is driven such that the electric charge is accumulated in each of the charge accumulation units in the number of times of integration of each of the groups,
selects an adjustment target object from the subject based on a pixel signal which is obtained by the first measurement, the pixel signal corresponding to the electric charge amount accumulated in each of the charge accumulation units,
calculates the number of times of integration in the second measurement based on the pixel signal of the pixels corresponding to the adjustment target object in the first measurement,
calculates a range shift amount which is a minimum value of a distance as a measurement target, which is determined in correspondence with a time interval from the emission timing to the accumulation timing in the second measurement, based on a distance to the adjustment target object in the first measurement,
performs the second measurement with the calculated number of times of integration and the calculated range shift amount, and
generates a distance image based on the pixel signal obtained in accordance with each measurement of the first measurement and the second measurement.

2. The distance image capturing device according to claim 1,
wherein the distance image processing unit performs the first measurement by combining the eoHDR driving with depth high dynamic range (dHDR) driving that is driven such that the number of times of reception of a reflected light is larger in the charge accumulation unit that accumulates the electric charge at the accumulation timing at which the reflected light arriving from the subject at a long distance is received than in the charge accumulation unit that accumulates the electric charge at the accumulation timing at which the reflected light arriving from the subject at a short distance is received, among the plurality of charge accumulation units included in the pixel.

3. The distance image capturing device according to claim 1,
wherein, in the first measurement, in a case where a first pixel signal, which is the pixel signal obtained from the pixel corresponding to the adjustment target object in a first group having a large number of times of integration, is in a saturation state that exceeds an upper limit of an electric charge accumulation amount, the distance image processing unit calculates the number of times of integration in the second measurement such that the pixel signal of the pixel corresponding to the adjustment target object is not saturated and is a value equal to or larger than a threshold value, based on a second pixel signal, which is the pixel signal obtained from the pixel corresponding to the adjustment target object in a second group having a small number of times of integration.

4. The distance image capturing device according to claim 1,
wherein, in the first measurement, in a case where a first pixel signal, which is the pixel signal obtained from the pixel corresponding to the adjustment target object in a first group having a large number of times of integration, is not in a saturation state that exceeds an upper limit of an electric charge accumulation amount, the distance image processing unit calculates the number of times of integration in the second measurement such that the pixel signal of the pixel corresponding to the adjustment target object is not saturated and is a value equal to or larger than a threshold value, based on the first pixel signal.

5. The distance image capturing device according to claim 1,
wherein the distance image processing unit performs, as the second measurement, a measurement by normal driving in which the electric charge is sequentially accumulated in the plurality of the charge accumulation units included in the pixel, and
calculates the range shift amount in the second measurement such that the reflected light arriving from the adjustment target object is received by a first charge accumulation unit that receives light at an earliest accumulation timing among the charge accumulation units.

6. The distance image capturing device according to claim 5,
wherein the distance image processing unit
calculates the range shift amount in the second measurement in a case where only reflected light that arrives from the adjustment target object is received in the first charge accumulation unit, and
calculates the number of times of integration in the second measurement so that the pixel signal corresponding to the first charge accumulation unit does not saturate, in a case where only the reflected light arriving from the adjustment target object is received in the first charge accumulation unit.

7. The distance image capturing device according to claim 1,
wherein the distance image processing unit
performs the first measurement by combining the eoHDR driving with the dHDR (depth High Dynamic Range) driving that is driven such that the number of times of reception of a reflected light is larger in the charge accumulation unit that accumulates the electric charge at the accumulation timing at which the reflected light arriving from the subject at a long distance is received than in the charge accumulation unit that accumulates the electric charge at the accumulation timing at which the reflected light arriving from the subject at a short distance is received, among the plurality of charge accumulation units included in the pixel,
determines the charge accumulation unit, which is a light receiving charge accumulation unit at which the reflected light arriving from the adjustment target object from the pixel signal obtained from the first measurement is received,
determines an amount of noise included in electric charge amounts accumulated in each of the charge accumulation units from the pixel signal obtained by the first measurement,
performs normalization processing with respect to a subtraction value subtracted from the amount of noise from the pixel signal corresponding to the light receiving charge accumulation unit, wherein
the normalization processing is a process that converts pixel signal of the light receiving charge accumulation unit to a signal value in a case where the number of times of integration of the light receiving charge accumulation unit is number of times of integration of the first charge accumulation unit that receives light at an earliest accumulation timing among the charge accumulation units, and
calculates the number of times of integration in the second measurement such that the pixel signal corresponding to the first charge accumulation unit does not exceed the subtracted value of the amount of noise from a saturation level, in a case where only the reflected light arriving from the adjustment target object is received by the first charge accumulation unit, using the pixel signal of the light receiving charge accumulation unit having the normalization processing performed.

8. The distance image capturing device according to claim 7, wherein
in a case where the light receiving charge accumulation unit is the first charge accumulation unit and a second charge accumulation unit,
the distance image processing unit
calculates a first light receiving value subtracted from the amount of noise from the pixel signal corresponding to the first charge accumulation unit,
calculates a second light receiving value subtracted from the amount of noise from the pixel signal corresponding to the second charge accumulation unit,
divides the second light receiving value using a ratio of a second number of times of integration with respect to a first number of times of integration in the normalization processing, and
calculates the number of times of integration in the second measurement such that a light receiving total amount, which multiplies the number of times of integration in the second measurement by the divided value which divides a sum of the second light receiving value and the first light receiving value after the normalization processing by the first number of times of integration, does not exceed the subtracted value of the amount of noise from a saturation level, wherein
the second charge accumulation unit is the charge accumulation unit receiving light at an earliest accumulation timing after the first charge accumulation unit,
the first number of times of integration is the number of times of integration set by the first charge accumulation unit in the dHDR driving of the first measurement, and
the second number of times of integration is the number of times of integration set by the second charge accumulation unit in the dHDR driving of the second measurement.

9. The distance image capturing device according to claim 7, wherein
at least three charge accumulation units are provided in the pixel,
in a case where the light receiving charge accumulation unit is the second charge accumulation unit and the three charge accumulation units,
the distance image processing unit
calculates a second light receiving value corresponding to the second charge accumulation value having the amount of noise subtracted from the pixel signal,
calculates a third light receiving value corresponding to the third charge accumulation value having the amount of noise subtracted from the pixel signal,
divides the second light receiving value in the normalization processing, using a ratio of a second number of times of integration with respect to a first number of times of integration,
divides the third light receiving value in the normalization processing, using a ratio of a third number of times of integration with respect to a first number of times of integration, and
calculates the number of times of integration in the second measurement such that a light receiving total amount, which multiplies the number of times of integration in the second measurement by the divided value which divides a sum of the second light receiving value and the third light receiving value after the normalization processing by the first number of times of integration, does not exceed the subtracted value of the amount of noise from a saturation level, wherein
the second charge accumulation unit is the charge accumulation unit receiving light at an earliest accumulation timing after the first charge accumulation unit,
in a case where the third charge accumulation unit is the charge accumulation unit receiving light at an earliest accumulation timing after the second charge accumulation unit,
the first number of times of integration is the number of times of integration set by the first charge accumulation unit in the dHDR driving of the first measurement,
the second number of times of integration is the number of times of integration set by the second charge accumulation unit in the dHDR driving of the first measurement, and
the third number of times of integration is the number of times of integration set by the third charge accumulation unit in the dHDR driving of the first measurement.

10. The distance image capturing device according to claim 7, wherein
at least four charge accumulation units are provided in the pixel,
in a case where the light receiving charge accumulation unit is a third charge accumulation unit and a fourth charge accumulation unit,
the distance image processing unit
calculates a third light receiving value corresponding to the third charge accumulation value having the amount of noise subtracted from the pixel signal,
calculates a fourth light receiving value corresponding to the fourth charge accumulation value having the amount of noise subtracted from the pixel signal,
divides the third light receiving value in the normalization processing, using a ratio of a third number of times of integration with respect to a first number of times of integration,
divides the fourth light receiving value in the normalization processing, using a ratio of a fourth number of times of integration with respect to a first number of times of integration,
calculates the number of times of integration in the second measurement such that a light receiving total amount, which multiplies the number of times of integration in the second measurement by the divided value which divides a sum of the third light receiving value and the fourth light receiving value after the normalization processing by the first number of times of integration, does not exceed the subtracted value of the amount of noise from a saturation level, wherein
the third charge accumulation unit is the charge accumulation unit receiving light at an earliest accumulation timing after the second charge accumulation unit, which is the charge accumulation unit receiving light at an earliest accumulation timing after the first charge accumulation unit,
the fourth charge accumulation unit is the charge accumulation unit receiving light at an earliest accumulation timing after the third charge accumulation unit,
the first number of times of integration is the number of times of integration set by the first charge accumulation unit in the dHDR driving of the first measurement,
the third number of times of integration is the number of times of integration set by the third charge accumulation unit in the dHDR driving of the first measurement, and
the fourth number of times of integration is the number of times of integration set by the fourth charge accumulation unit in the dHDR driving of the first measurement.

11. A distance image capturing method performed by a distance image capturing device including a light source unit that is configured to emit an optical pulse to a measurement space, a light receiving unit that includes a pixel circuit in which a plurality of pixels, each including a photoelectric conversion element that generates an electric charge in accordance with incident light and a plurality of charge accumulation units that accumulate the electric charge are arranged in a two-dimensional matrix, and a pixel driving circuit which distributes and accumulates the electric charge in each of the charge accumulation units at a predetermined accumulation timing synchronized with an emission timing at which the optical pulse is emitted, and a distance image processing unit that is configured to calculate a distance to a subject present in the measurement space based on an electric charge amount accumulated in each of the charge accumulation units,
wherein the distance image processing unit
performs a first measurement and a second measurement,
classifies the pixels into at least two groups having different numbers of times of integration for repeating processing of accumulating the electric charge in each of the charge accumulation units in the first measurement, and performs even odd high dynamic range (eoHDR) driving that is driven such that the electric charge is accumulated in each of the charge accumulation units in the number of times of integration of each of the groups,
selects an adjustment target object from the subject based on a pixel signal which is obtained by the first measurement, the pixel signal corresponding to the electric charge amount accumulated in each of the charge accumulation units,
calculates the number of times of integration in the second measurement based on the pixel signal of the pixels corresponding to the adjustment target object in the first measurement,
calculates a range shift amount which is a minimum value of a distance as a measurement target, which is determined in correspondence with a time interval from the emission timing to the accumulation timing in the second measurement, based on a distance to the adjustment target object in the first measurement,
performs the second measurement with the calculated number of times of integration and the calculated range shift amount, and
generates a distance image based on the pixel signal obtained in accordance with each measurement of the first measurement and the second measurement.
